(19) United States
(12) Patent Application Publication
(10) Pub. No.: US 2013/0243185 A1
(43) Pub. Date: Sep. 19, 2013

(54) AUDIO ENCRYPTION SYSTEMS AND METHODS WITH SECURE EDITING

(71) Applicants: Jackson Robert Harper, Norwood, MA (US); Alexander Poston, JR., Nashville, TN (US)

(72) Inventors: Jackson Robert Harper, Norwood, MA (US); Alexander Poston, JR., Nashville, TN (US)

(21) Appl. No.: 13/419,282

(22) Filed: Mar. 13, 2012

(51) Int. Cl. H04L 9/28

(52) U.S. Cl. 380/28

(57) ABSTRACT

Encryption systems and methods for audio data, and more particularly, for complete audio encryption of recorded data for transmission, management, review, editing and modification or transformation of selected segments of encrypted audio data, without compromising data security by exposing unencrypted data at any time.

### BACKGROUND OF THE INVENTION

1. Field of the Invention

The present invention relates to encryption systems and methods for audio data, and more particularly, for complete security for audio encryption of recorded data for transmission, management, editing, and modification or transformation thereof.

2. Description of the Prior Art

Prior art includes automatic systems and methods for transcription of medical dictation, including, by way of example, the following:

US Patent Application Publication No. 20080288250 by inventors Renillo, et al. for Real-time transcription system, published Nov. 20, 2008 for a transcription system and method that includes a transcription terminal for recording electronically generated text as units of transcribed text, and a conversion unit for translating the units of ascribed text into a generally accurate transcript of the electronically generated text and converting said transcript into a signal to be transmitted to an authorized receiving unit over a communication link, including a wireless access point for transmitting serial data representing the transcript, and suppression of an automatic network identifier.

US Patent Application Publication No. 20050187766 by inventors Renillo, et al. for Real-time transcription system, published Aug. 25, 2005 for a transcription system and method that includes a transcription terminal for recording spoken words as units of transcribed text, and a conversion unit for translating the units of transcribed text into a generally accurate transcript of the spoken words and converting said transcript into a signal to be transmitted to an authorized receiving unit over a communication link, including a wireless access point for transmitting serial data representing the transcript, and suppression of an automatic network identifier.

US Patent Application Publication No. 20090197573 by inventor Rofougaran for Secure use of a handheld computing unit, published Aug. 6, 2009 for a handheld computing unit including a wireless transceiver and a processing module, which is coupled to detect initiation of the handheld computing unit so that when the initiation is detected, the processing module initiates collection of a user security parameter, receives an input corresponding to the user security parameter, and converts the input into the outbound symbol stream, which is converted into an outbound wireless signal and transmitted; the processing module further converts an inbound symbol stream into a security response, interprets the security response, and when it is favorable, enables use of the handheld computing unit.

Relevant art also includes systems and methods for secure audio transmission and/or communication, including, by way of example, the following:

US Patent Application Publication No. 20030169730 by inventors Narasimhan, et al. for Method and process for signaling, communication and administration of networked objects, published Sep. 11, 2003 for systems and processes for communication of messages between one or more networked objects on circuit data networks, including means for representation of various communication types, including content description and disposition rules, delivery and routing description and rules, conversion and translation descriptions and rules, and methods for interactions and for administration over one or more network types, through one or more communication protocol types, to one or more destination types. The delivery of messages and other communication over various communication protocols in addition to emails are described, as well as methods for administering and managing rules for directing and transforming the messages and communications for purposes of routing or delivery to one or more specific destinations.

US Patent Application Publication No. 20110222688 by inventors Graham, et al. for One vault voice encryption, published Sep. 15, 2011 for secure voice solutions for mobile communication device Blackberry 9000 (BOLD™), providing that rather than making encrypted voice calls through traditional GSM cellular phone calls, voice data is received from the user using a device microphone and built-in media player software; that data is then encrypted and sent as an IP packet; the device then receives as IP packets, encrypted voice communication from the other party in the encrypted call, which in turn are decrypted in the device and then played back on a second media player running on that device. This requires that the device runs two media players simultaneously, in order to in effect, simulate a cellular telephone call, so that PDA-type devices provide for encrypted calls wherein the calls are placed over the Internet, rather than traditional cellular data signals.

US Patent Application Publication No. 20110302408 by inventors McDermott, et al. for Secure communication systems, methods, and devices, published Dec. 11, 2011 for secure communication systems including voice call processing server, user database in communication with the server, a security gateway in communication with the server and the database, wherein the gateway transmits an encrypted signaling key and at least one media key in response to validating a mobile device using configuration data stored in the database, wherein the server tracks call traffic encrypted using the at least one media key, and the traffic being routed through the internet.

US Patent Application Publication No. 20120020475 by inventor Altmann for Mechanism for partial encryption of data streams, published Jan. 26, 2012 for partial encryption of data streams, with methods including receiving a data stream at a data transmitting device, wherein the data stream has content including one or more audio content, video content, and control content; determining one or more content that are to be encrypted; partially encrypting the data stream by encrypting the one or more content, and leaving the other content unencrypted, and transmitting from the data transmitting device, the partially encrypted data stream to a data receiving device.

None of the prior art or relevant art cited or known at the time of the invention addresses the longstanding, unmet need for secure audio data storage, review, transmission, management, and transcription from audio to corresponding text (where appropriate), much less in the rapidly changing environment in any business or industry, in particular in healthcare applications of electronic health records (EHR) or electronic medical records (EMR), where systems and processes need to be moving toward further efficiency, cost reduction, and paperless systems, all while requiring patient data privacy and security.

### SUMMARY OF THE INVENTION

The present invention relates to encryption systems and methods for complete audio encryption of recorded data for transmission, management, and modification or transformation thereof from a mobile device without compromising data security by exposing unencrypted data at any time.

It is an object of this invention to provide systems and methods for real-time encryption of recorded audio data for saving, managing, editing, transmitting, reviewing, and combinations thereof, wherein all functions are performed on a mobile device. Preferably, the initial audio inputs are also received by the same mobile device.

Accordingly, a broad embodiment of this invention is directed to systems and methods having a remote server computer in communication with a network over which distributed users having authorization to access the system provide inputs of audio from respective mobile devices having iOS operating systems, wherein the inputs are preferably provided as voice-based audio of spoken words, that are transformed in real time to encrypted audio data upon recordation on the mobile device, and wherein the encrypted audio data is automatically available for selectively activating functions on the mobile device, within a software application operable thereon, including saving, managing, editing, deleting to end, transmitting, and/or reviewing and for automatically transforming the encrypted audio data to encrypted text that corresponds to the audio inputs.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram of one embodiment of the invention including at least one mobile device, remote server computer/database, and communications network.

FIG. 2 is another schematic diagram of an embodiment of the present invention including at least one mobile device, remote server computer/database, and communications network.

FIG. 3 shows a screen shot of data stored in an audio files database and a screenshot of the corresponding files on disk.

FIG. 4 illustrates a screen shot of an interactive graphic user interface (GUI) on a mobile device according to one embodiment of the present invention.

FIG. 5 is a flow diagram of methods according to the present invention, specifically relating to mobile device-based editing of encrypted audio data.

FIG. 6 shows a screen shot of another interactive GUI on a mobile device according to one embodiment of the present invention.

### DETAILED DESCRIPTION

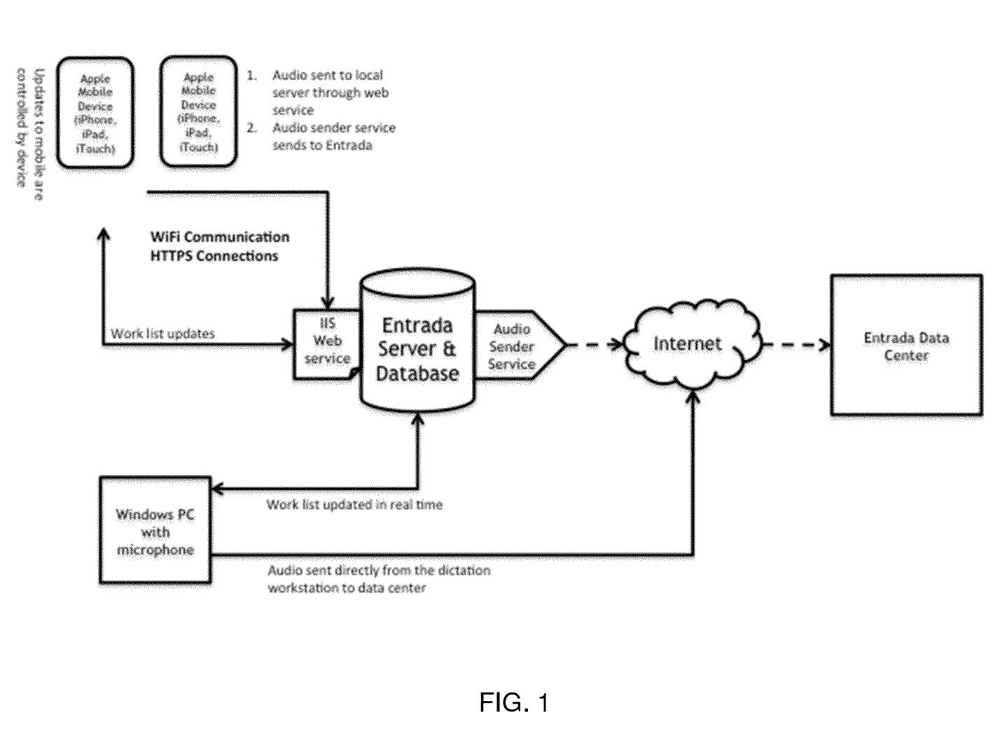

Referring to the drawings in general, the illustrations are for the purpose of describing preferred embodiments of the invention, and are not intended to limit the invention thereto. FIG. 1 illustrates a schematic diagram of a remote server computer and network connection with at least one mobile device in communication with the remote server computer for providing the means for recording or receiving audio inputs via the at least one mobile device and immediately transforming the audio inputs into encrypted audio data recorded on the device. In preferred embodiments, at least one mobile device is shown, namely an Apple mobile device selected from iPhone smartphone, iPad tablet, iPod Touch PDA, and combinations thereof. The at least one mobile device receives audio inputs, which are sent via WiFi communication and/or https connections to a local server through a web service and/or to a remote server computer/data center, as illustrated.

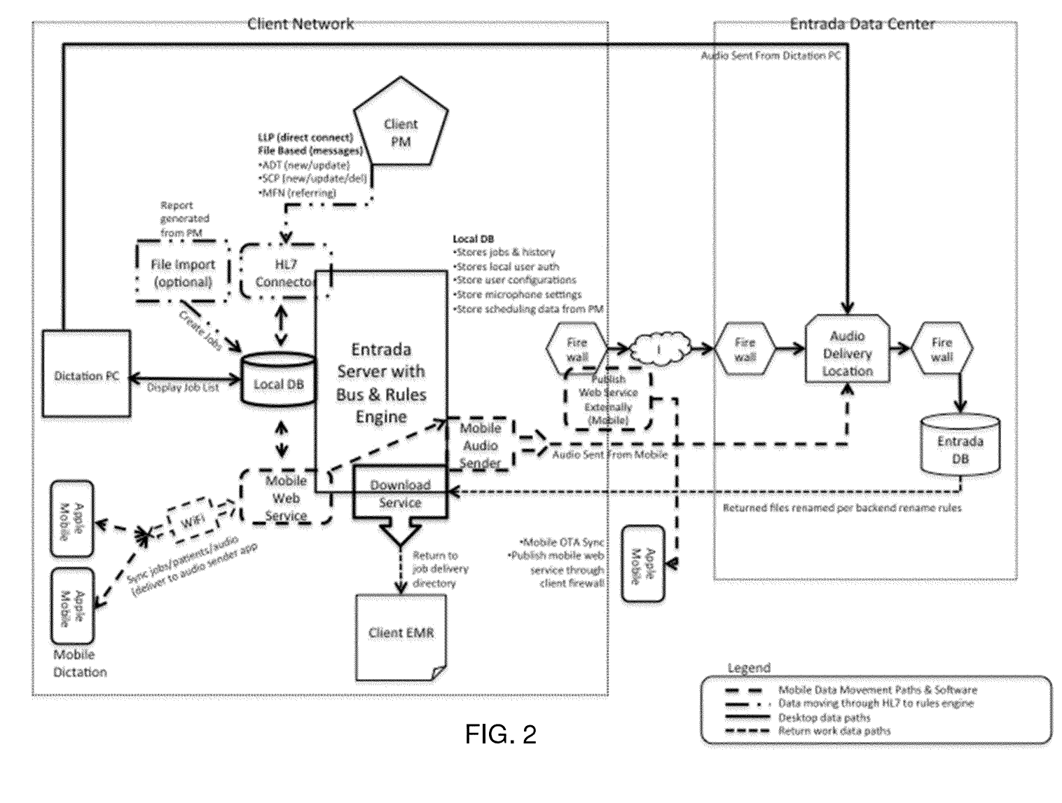

Significantly, the systems and methods of the present invention thus provide for totally and completely encrypted audio as the audio inputs are being recorded, i.e., in real time or near real-time, to ensure data security of the audio recorded, even if the device is compromised. Furthermore, all other processing of the encrypted audio data including but not limited to reviewing, saving, transmitting, transcribing, editing, and combinations thereof provide for encrypted data management, i.e., all audio is encrypted and the audio data is never un-encrypted in storage on the device. FIG. 2 is another schematic diagram of an embodiment of the present invention including at least one mobile device, remote server computer/database, and communications network.

The methods of the present invention include steps for mobile devices having iOS operating systems, wherein the inputs are preferably provided as voice-based audio of spoken words, to be transformed in real time to encrypted audio data upon recordation on the mobile device, and wherein the encrypted audio data is automatically available for selectively activating functions on the mobile device, within a software application operable thereon, including saving, managing, editing, deleting to end, transmitting, and/or reviewing and for automatically transforming the encrypted audio data to encrypted text that corresponds to the audio inputs.

The application provides for a voice audio file to be captured through a microphone in the mobile device, or wirelessly via Bluetooth technology or any other microphone-based input connected with the device, either wirelessly or with wired connection, and encrypted in real time to ensure complete data security, whether in audio or data text format, even when editing. At the time of recording of the audio inputs by the mobile device, the system automatically converts or transforms the audio inputs into encrypted audio data.

The system automatically provides for the data-secure functions of editing, including review, rewind, insert, delete, and overwrite any dictation segment after it has been automatically transformed into encrypted audio (no user intervention occurs).

The systems and methods of the present invention are further operable for automatically storing the encrypted audio as a series of encrypted audio data segments within a database, which contains offsets into those slices for playback. A segment refers to an on disk segment of data, a slice is a portion of a segment. Multiple slices could point to different sections of a single segment. Also, as an analogy, an entire recording is considered a library, wherein a segment represents a book, and a slice represents a chapter or several chapters in that book. This format allows editing operations on the encrypted data to occur instantly and defers editing computations until playback, at a later time.

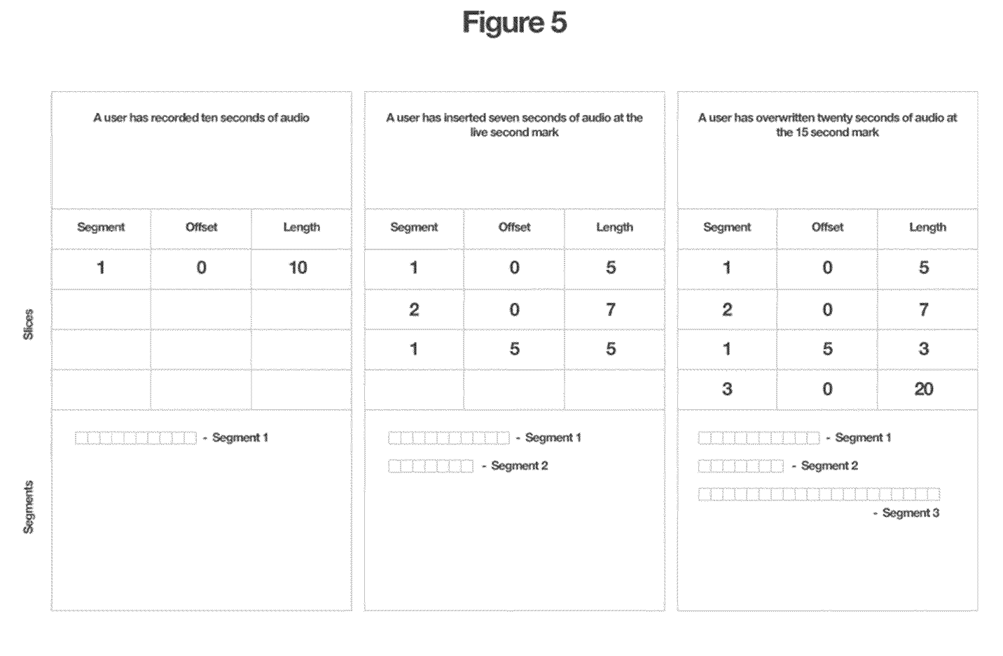

FIG. 5 is a flow diagram of methods according to the present invention, specifically relating to mobile device-based editing of encrypted audio data. FIG. 5 illustrates methods for the state of the audio segments/slices over three different editing operations of the present invention. Audio inputs are received by the mobile device via a microphone, or wirelessly via Bluetooth technology or any other microphone-based input connected with the device, either wirelessly or with wired connection, and automatically transformed into encrypted audio data, and stored in memory on the mobile device. The encrypted audio data available for editing includes a first continuous segment of audio input recorded on the mobile device; the software application that is operating on the mobile device automatically transforms the first continuous segment of audio input into encrypted audio data at the time of recordation to ensure complete data security. The encrypted data corresponding to the first continuous segment of audio input recorded is further transformed into a series of segments of exactly the same length or size that are saved to an on disk file. Then the authorized dictator user for the mobile device provides a selection input via interactive graphic user interface, wherein the selection includes a specific editing function to be performed to a specific slice of encrypted data (wherein a slice of encrypted data is a subset of the segment), and then the mobile device software application automatically performs the specific editing function to the specific slice of encrypted data within a data segment.

For an inserting function, an insert audio input is recorded and the corresponding encrypted audio data associated with the insert audio input is automatically offset within the first segment of encrypted data. After the insertion, the encrypted data with insertion are transformed into a new edited encrypted data file, and stored on the mobile device. At a later point, the entire file is transmittable via network communication to the remote server computer.

During playback or upload functions of the encrypted audio data files, when the underlying audio functions of the present invention request audio data, the remote server and/or database is automatically queried, and encrypted audio data automatically read from the encrypted audio data slices based on the offsets and lengths of encrypted audio data that is automatically stored in the remote server and/or database.

By way of example of automatic editing functions of encrypted audio data according to the present invention, consider the following.

### Example

A dictator user records a continuous ten seconds of audio input on a mobile device; the software operable on the mobile device automatically transforms the audio input into encrypted audio data at the time of recordation to ensure complete data security:

On disk files:
audio.db—offsets database
segment-1—encrypted chunk of ten seconds of audio

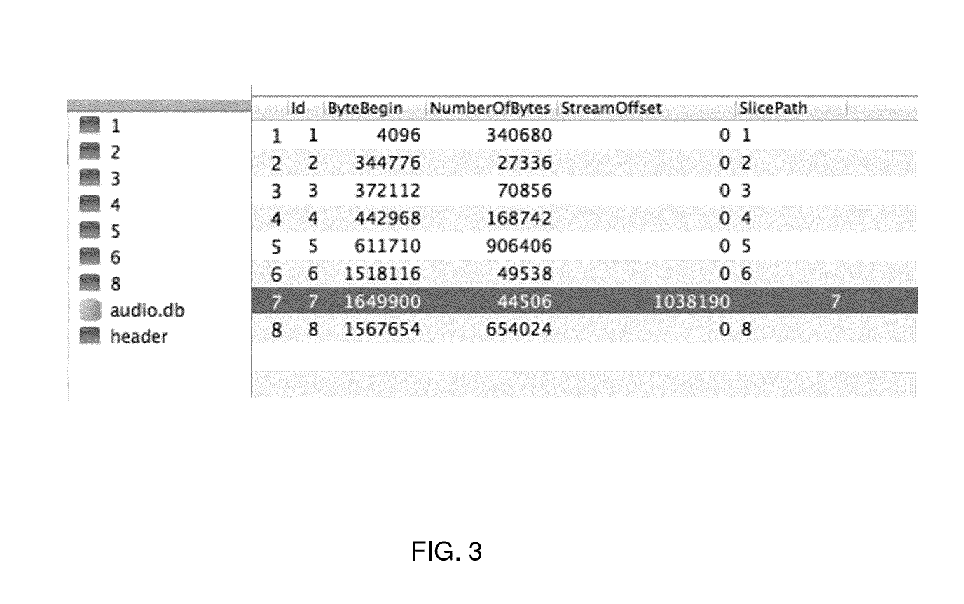

The mobile device is operable upon user selection via interactive user interface (as illustrated in FIG. 3, and the encrypted data file automatically “rewinds” by providing an indication of selection at the five second mark, and automatically inserts seven seconds of new audio input created by the user and recorded onto the device:

On disk files:
audio.db—offsets database
segment-1—encrypted chunk of ten seconds of audio
segment-2—encrypted chunk containing the new seven seconds of audio using insert feature

audio.db now contains three slices:

The first pointing to segment 1 with a length of five seconds.

The second pointing to segment 2 with a length of seven seconds.

The third pointing to segment 1 with an offset of five seconds and length of five seconds.

The following editing functions for encrypted audio data are provided by the present invention: “Delete to end” operable to remove all audio data after the current position selected; “Insert” operable to split the encrypted audio file at the current position selected or indicated, and to insert automatically a new recorded audio at that position, wherein the new recorded audio is automatically transformed to new encrypted recorded audio data for insertion; and “Overwrite” operable to split the encrypted audio file at the current position selected or indicated, and to automatically overwrite the encrypted audio data from the original or existing audio file as new audio input is recorded. Additional editing functions for encrypted audio data that are provided by the present invention include “Playback” of audio files; and “Upload” operable for automatically creating streams of encrypted audio data files for uploading to the remote server computer or to another computer external to the mobile device onto which the audio input was originally captured.

To illustrate one aspect of the present invention, in particular the editing function further including steps of overwrite, FIG. 3 shows a screen shot of the data stored in an audio files database and just a screenshot of the corresponding files on disk. In the attached screenshot the system automatically created encrypted audio data from an audio input from a dictation user, and provided for the system to create a number of continuous slices (in series) of the encrypted audio data by recording and then pausing; these slices are numbered in series accordingly on the right side of the screen shot. However, for the encrypted audio data having a slice 6, the system provided for the function of rewind through most of that particular slice (number 6) and began recording in an overwrite mode, thereby automatically transforming the encrypted data series to include a slice 7 of the encrypted audio data, which has a stream offset as illustrated in the left side of the screen shot of FIG. 3.

Advantageously, the systems and methods of the present invention provide for automatic transformation of the audio inputs into encrypted audio data as it is being recorded by encryption of a chunk of data, i.e., a predetermined amount of data, preferably a predetermined amount of data, wherein each predetermined amount of data is exactly the same length; in a most preferred embodiment, the predetermined amount of data is equivalent to 128 bytes. The recording, saving or storing, transmitting to the remote server computer over the network (wireless or otherwise), reviewing, editing (including inserting, deleting, overwriting, etc.) are steps that are all performed on the encrypted audio data, thereby ensuring that the audio inputs, once recorded on the mobile device, are secure. In other words, dictator users can dictate patient-specific health information or unstructured data elements or segmented note data elements while still having the speed and flexibility of mobility, i.e., using a mobile device for targeted, field-specific dictation of audio data into a templated interactive graphic user interface (GUI), wherein on a real-time basis of dictation, the audio data stream is transformed automatically by the system into encrypted chunks of recorded data.

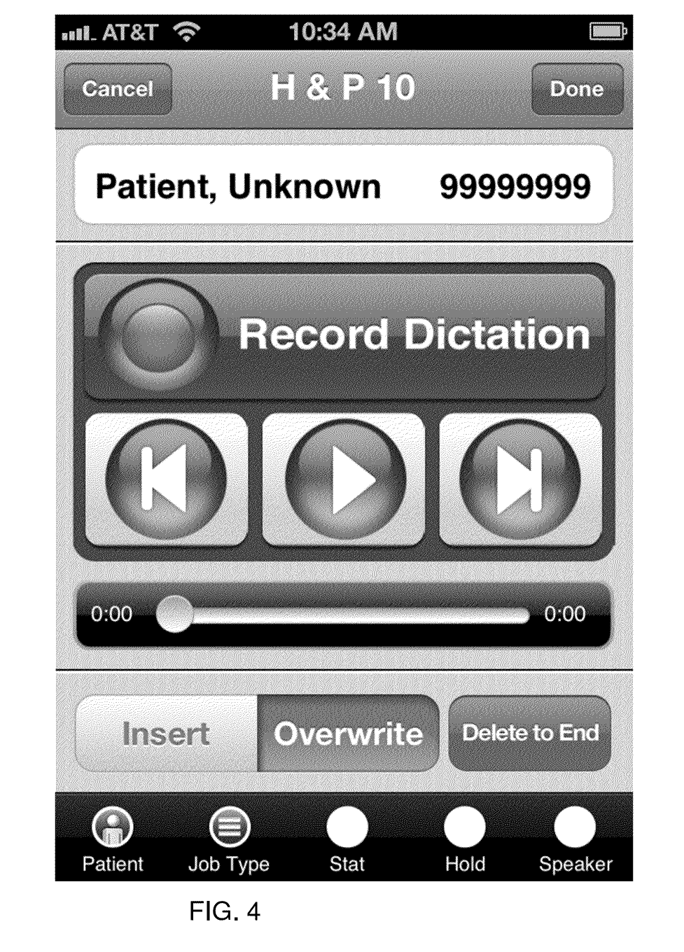

FIG. 4 illustrates one interactive GUI for editing encrypted audio data on a mobile device, with click-select or touch-select items that control corresponding functionality relating to editing as set forth in the foregoing.

Overall, the present invention provides methods for secure audio data management including the steps of: providing a base system including a remote server computer having a memory, a processor, and power supply connected thereto, in communication via a network with at least one mobile device constructed and configured for recording or receiving an audio input; and the system receiving the audio input by the at least one mobile device and automatically transforming the audio input into encrypted audio data at the time the audio input is being recorded on the at least one mobile device, and the system automatically transforming the encrypted audio data into a series of encrypted audio data slices, each of the slices having an order and a content, respectively, wherein each of the encrypted audio data slices is editable in its encrypted form, without affecting the order or content of the non-edited slices, thereby providing completely encrypted audio for secure audio data management.

Also, method steps of the present invention further include at least one mobile device(s) communicating with the remote server computer via wireless communication over the network for transmitting the encrypted audio data, wherein the method provides the audio data and/or its transcribed equivalent are completely encrypted from the time of generation and capture as the audio input by the at least one mobile device. Furthermore, immediately upon recording the audio input, the system automatically transforms the encrypted audio data into a series of encrypted audio data slices, each of the slices having an order and a content, respectively, wherein each of the encrypted audio data slices is editable in its encrypted form, without affecting the order or content of the non-edited slices.

The management of the audio data, which is secure at all times, includes but is not limited to the following functions: reviewing, saving, transferring to a remote data server (database), editing, editing remotely from the dictation generation and/or on a mobile device by the dictation user/generator, deleting, forwarding to remote server and/or database for storage and other processing, and combinations thereof.

Systems and methods according to the present invention have applications for providing innovative documentation solutions that simplify the process of adopting and using a mobile-based audio input capture, automated immediate conversion to encrypted audio data, and editing of the encrypted audio data on the mobile device on which the audio inputs were initially created.

Integration of data and the ability for disparate entities to share encrypted and private documentation with complete security is a critical element of any infrastructure, regardless of the industry application of the present invention. Particular commercial applications include outpatient clinics (including specialists and multi-specialty groups), hospitals, and surgery centers, for the automated, encrypted audio dictation and corresponding text-based documentation for improved speed, accuracy, and physician productivity, while also preserving complete data security and patient data privacy.

Beyond the medical and healthcare industry for dictation and transcription, the systems and methods of the present invention also have application in other areas where secure audio recording, saving, management, editing, reviewing, and transcribing, and combinations thereof, are used. By way of example and not limitation, other industries include: law enforcement, legal, education, consulting, business, financial and accounting, etc. Thus, the present invention systems and methods provide for multiple entities to share secure, confidential notes created to document services performed at the point of provision, (e.g., in medical practices this means patient care), with all notes, from audio recording at the point of dictation on a mobile device to transcription, being completely encrypted to ensure data security. The data encryption provides complete security at any time data must be captured remotely and transferred into a remote server and/or database.

For example, once again in the medical field, physicians (doctors, or dictator users) must do an operative report after performing surgery at a location. The present invention systems and methods and software are operable to finalize and route reports dictated at the hospital or surgery center facility to the doctor at his home clinic or another remote location for review and signature, all while retaining complete encryption of the dictation or recorded audio. All audio-related functions are operable inside the software application of the present invention, preferably from a mobile device, such as a tablet device, smartphone, mobile communication device, and the like, and more preferably, those mobile devices running Apple's proprietary iOS platform.

The present invention provides for complete data security because the audio data and/or corresponding text data are encrypted at every stage of data management, from the time of initial recording, through editing, saving, etc. In other words, dictator users can dictate patient-specific narrative text or discrete data elements while still having the speed and flexibility of mobility, i.e., using a mobile device for targeted, field-specific dictation of audio data into a templated interactive graphic user interface (GUI), wherein on a real-time basis of dictation, the audio data stream is transformed automatically by the system into encrypted chunks, modules, segments, or slices of recorded data.

The present invention provides a documentation solution to any audio-based dictation environment, including by way of example, but not limited to, outpatient clinic, surgery center and hospital environments, as well as law enforcement, through an automated, secure information workflow using encrypted data “chunks”, modules, segments, and/or slices, which are predetermined lengths of recorded encrypted data. This audio input originates from a suitable mobile device, including but not limited to devices such as the commercially available products from Apple, namely commercial products including mobile phones, smartphones, personal mobile devices, tablet computers, respectively known under trademarks such as iPhone, iPod Touch, and/or iPad.

Significantly, according to the present invention, every audio recording immediately becomes encrypted audio data, i.e., the audio data and/or its transcribed equivalent are completely encrypted from the time of generation on a mobile device, including and not limited to transfer to a remote data server (database), editing remotely from the dictation generation and/or on a mobile device by the dictation user/generator, saving, and combinations thereof.

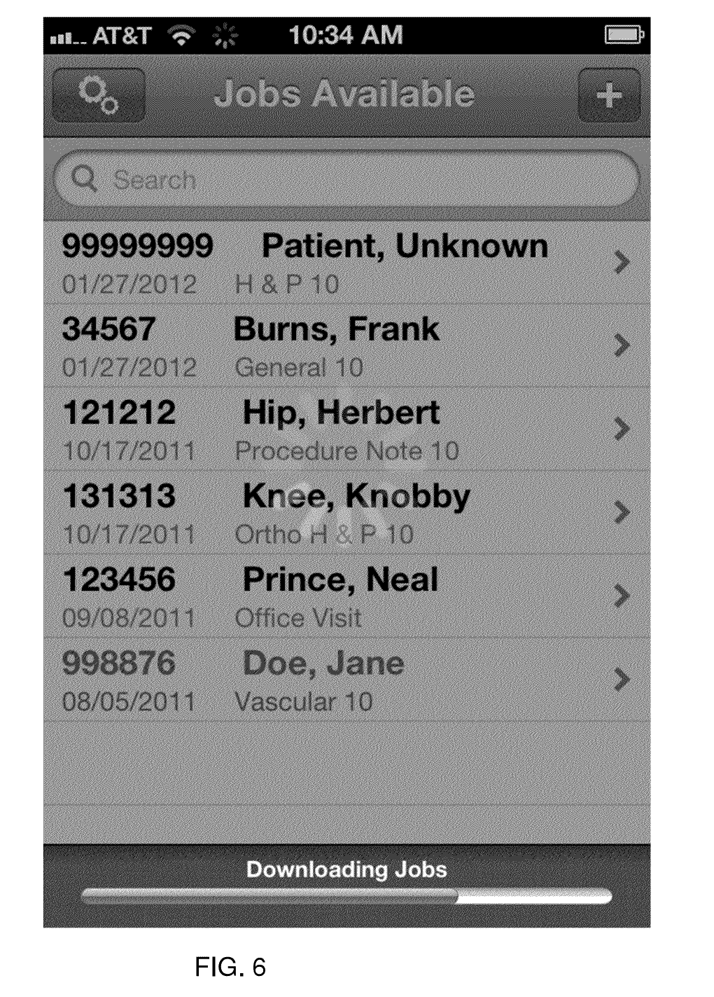

Significantly, according to the present invention, every job or recordation of audio is stored as an encrypted job, i.e., the audio data is completely encrypted from the time of generation on a mobile device, including and not limited to, editing from the dictation generation and/or on a mobile device by the dictation user/generator, saving, editing, and combinations thereof. In one embodiment of the present invention, a dictator user either begins recording or selects from a listing of jobs to be dictated in an interactive graphic user interface (GUI) on a display. A GUI illustrating “jobs available” is shown in FIG. 6, including a search function and a status bar indicating jobs downloading completed and remaining on a continuous line bar (at bottom). The mobile device receives a voice audio file that is captured through a speech microphone either built-in and/or peripheral device on the dictator's mobile device, smartphone, etc. The user has the ability to rewind and edit their dictation at any point in the encrypted audio data, without having to edit the entire data file by simply selecting the point at which the editing is to occur.

This is a mobile-device-based application used to capture audio inputs that are automatically transformed to an encrypted audio data format upon recordation on the mobile device. In addition to the editing functions set forth in the foregoing, the encrypted audio data may be processed for automatic conversion from audio to digital text, while maintaining complete encryption of the data.

A secure login/password or other user security may be provided on the mobile device. For example a specific dictator's username and password being entered and saved into the device's configuration settings, the dictation user authenticates by using a client-specific code (unique client identifier, e.g., but not limited to login/password combination).

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for secure audio data management and editing comprising the steps of:
Providing a mobile device constructed and configured for receiving or recording an audio input;
receiving or recording the audio input by the mobile device and automatically transforming the audio input into encrypted audio data at the time the audio input is being recorded on the mobile device;
automatically transforming the encrypted audio data into a series of encrypted audio data slices, each of the slices having an order and a content, respectively, wherein each of the encrypted audio data slices is editable in its encrypted form, without affecting the order or content of the non-edited slices,
thereby providing completely encrypted audio for secure audio data management.

2. The method of claim 1, further including the step of editing the encrypted audio data at select segments without editing the remaining encrypted audio data.

3. The method of claim 1, wherein the method provides the audio data and/or its transcribed equivalent are completely encrypted from the time of generation and capture as the audio input by the mobile device.

4. The method of claim 1, wherein the step of automatically transforming the audio inputs into encrypted audio data occurs simultaneously with audio inputs recording by the mobile device.

5. The method of claim 1, wherein the audio inputs are automatically encrypted in a series of data modules (chunks of data).

6. The method of claim 5, wherein the audio inputs are automatically encrypted in a series of data modules including a predetermined amount of data.

7. The method of claim 6, wherein the predetermined amount of data is equivalent to about 128 bytes.

8. The method of claim 1, further including the step transforming the encrypted audio data by editing on the mobile device via an interactive GUI.

9. The method of claim 8, wherein the step of editing further includes the functions of review, rewind, insert, delete, overwrite, and combinations thereof, for any dictation segment after it has been automatically transformed into encrypted audio data in a series of data modules.

10. A method for secure audio data management and editing comprising the steps of:
providing a base system including a remote server computer having a memory, a processor, and power supply connected thereto, in communication via a network with at least one mobile device constructed and configured for receiving an audio input;
the system receiving the audio input by the at least one mobile device and automatically transforming the audio input into encrypted audio data at the time the audio input is being recorded on the at least one mobile device;
the system automatically transforming the encrypted audio data into a series of encrypted audio data slices, each of the slices having an order and a content, respectively, wherein each of the encrypted audio data slices is editable in its encrypted form, without affecting the order or content of the non-edited slices,
thereby providing completely encrypted audio for secure audio data management.

11. The method of claim 10, further including the step of the at least one mobile device communicating with the remote server computer via wireless communication over the network for transmitting the encrypted audio data.

12. The method of claim 10, wherein the method provides the audio data and/or its transcribed equivalent are completely encrypted from the time of generation and capture as the audio input by the at least one mobile device.

13. The method of claim 10, wherein the method provides for the audio data to be encrypted at all times, including and not limited to transfer to a data server (database), editing from the dictation generation and/or on a mobile device by the dictation user/generator, saving, and combinations thereof.

14. The method of claim 10, wherein the step of automatically transforming the audio inputs into encrypted audio data occurs simultaneously with audio inputs recording by the at least one mobile device.

15. The method of claim 14, wherein the audio inputs are automatically encrypted in a series of data modules (chunks of data).

16. The method of claim 14, wherein the audio inputs are automatically encrypted in a series of data modules including a predetermined amount of data.

17. The method of claim 16, wherein the predetermined amount of data is equivalent to about 128 bytes.

18. The method of claim 10, further including the step of the system providing further transformation of the encrypted audio data, including editing via the at least one mobile device.

19. The method of claim 18, wherein the step of editing further includes the functions of review, rewind, insert, delete or trim, overwrite, and combinations thereof, for any dictation segment after it has been automatically transformed into encrypted audio data in a series of data modules.
